(19) United States
(12) Patent Application Publication
(10) Pub. No.: US 2012/0274526 A1
(43) Pub. Date: Nov. 1, 2012

(54) Line Conversion Structure and Antenna Using the Same

(75) Inventor: Shinichi Koriyama, Kirishima-shi (JP)

(73) Assignee: KYOCERA CORPORATION, Kyoto-shi, Kyoto (JP)

(21) Appl. No.: 13/318,334

(22) PCT Filed: Dec. 16, 2010
(86) PCT No.: PCT/JP2010/072720

§ 371 Date: Nov. 30, 2011

(30) Foreign Application Priority Data
Dec. 22, 2009 (JP) 2009-289990
Jan. 25, 2010 (JP) 2010-013207
Jun. 29, 2010 (JP) 2010-148374

(51) Int. Cl. H01Q 13/10; H01P 5/08

(52) U.S. Cl. 343/767; 333/24 R

(57) ABSTRACT

In a line conversion structure, a slot line includes a slot ground conductor connected to a ground layer with a through conductor that passes through the dielectric layer, a slot signal conductor, and a slot disposed between the slot ground conductor and the slot signal conductor. A signal conductor of a microstrip line is orthogonal to the slot ground conductor and the slot, with a gap between the signal conductor and the slot ground conductor, and an end of the signal conductor is connected to the slot signal conductor, and a length L of a portion of the slot ground conductor, the portion being parallel to the signal conductor with the gap, is less than or equal to 0.25 times a wavelength of a signal transmitted through the microstrip line.

### TECHNICAL FIELD

The present invention relates to a line conversion structure in which a high-frequency transmission line formed in a dielectric layer is converted into a slot line, and in particular to a line conversion structure suitable for interlayer connection in a transmission line, connection to an antenna, connection to a waveguide, or the like in a semiconductor element storage package or a wiring board that is preferable for housing or mounting semiconductor elements intended for high frequencies ranging from microwave to millimeter-wave frequency bands, and to an antenna using such a line conversion structure.

### BACKGROUND ART

With the arrival of the advanced information age in recent years, utilization of radio waves ranging from the microwave frequency band of 1 to 30 GHz to even the millimeter-wave frequency band of 30 to 300 GHz for information transmission is being considered. For example, an applied system such as a domestic high-speed wireless transmission system (wireless personal area network (PAN)) using 60 GHz has now been proposed.

Conventionally, with a wiring board in/on which semiconductor elements for high frequencies (hereinafter simply referred to as “high-frequency elements”) used in such an applied system or the like are housed/mounted, interlayer connection in a transmission line or connection to an antenna, for example, is in many cases established via a slot line.

A wiring board disclosed in Patent Literature 1 is known as an example of a wiring board using such transmission line connection via a slot line. In this wiring board, a microstrip line configured in an upper dielectric layer and an output microstrip line configured in a lower dielectric layer are connected at high frequencies with electromagnetic coupling via a slot provided between the dielectric layers.

The characteristic of the electromagnetic coupling between the microstrip lines and the slot in such a wiring board varies depending on a stub length and a slot length, the stub length being a length from an open end of each microstrip line to the center of the slot. In the case where such a wiring board is manufactured using a printing or lamination technique, the variation in the slot length is determined by only the variation in print dimensions and is thus relatively small. On the other hand, the variation in the stub length readily increases due to the variation in print position in forming the microstrip lines, the variation in print position in forming the slot, and layer-to-layer misalignment in laminating the upper and lower dielectric layers, which results in the problem that there is variation in the characteristic of the electromagnetic coupling between the microstrip lines and the slot.

A wiring board disclosed in Patent Literature 2 is also known as an example of a line conversion structure in which a line for transmitting high frequencies is converted into a slot line. This example gives a wiring board for connecting a coplanar line to a dielectric waveguide via a slot formed in the same plane as the coplanar line. In this case, since the coplanar line and the slot are formed in the same plane, the variation in the stub length is relatively small because it depends only on the variation in print dimensions without experiencing the influence of the variation in print position and the layer-to-layer misalignment as described in the above case. Accordingly, the variation in the characteristic of the conversion from the coplanar line to the slot is reduced.

Furthermore, a wiring board disclosed in Patent Literature 3 is known as an example of a line conversion structure in which a microstrip line is converted into a coplanar line. This example gives a wiring board in which the conversion into a coplanar line is achieved by, while reducing the width of a signal conductor of the microstrip line, forming a ground conductor on both sides of the signal conductor with a gap provided between the ground conductors and the signal conductor, and reducing these gaps so as to make the impedance constant. With such a wiring board, it is not easy to prepare such a design for reducing the gaps between the signal conductor and the ground conductors formed on both sides of the signal conductor in order to make the impedance constant.

### CITATION LIST

### Patent Literature

Patent Literature 1: Japanese Unexamined Patent Publication JP-A 3-129903 (1991)
Patent Literature 2: Japanese Unexamined Patent Publication JP-A 2002-26611
Patent Literature 3: Japanese Unexamined Patent Publication JP-A 6-303010 (1994)

### SUMMARY OF INVENTION

### Technical Problem

It is an object of the invention to provide a line conversion structure that converts a high-frequency transmission line into a slot line with a small variation in conversion characteristics and a small loss in conversion.

### Solution to Problem

A line conversion structure according to an embodiment of the invention is a line conversion structure for converting a high-frequency transmission line into a slot line. The high-frequency transmission line includes a dielectric layer, a signal conductor disposed on an upper surface of the dielectric layer, and a ground layer disposed on a lower surface of the dielectric layer. The slot line includes a slot ground conductor, a slot signal conductor, and a slot. The slot ground conductor is disposed on the upper surface of the dielectric layer and connected to the ground layer with a through conductor that passes through the dielectric layer. The slot signal conductor is disposed on the upper surface of the dielectric layer. The slot is disposed between the slot ground conductor and the slot signal conductor. The signal conductor of the high-frequency transmission line is orthogonal to the slot ground conductor and the slot, with a gap between the signal conductor and the slot ground conductor, and an end of the signal conductor is connected to the slot signal conductor. A length of a portion of the slot ground conductor, the portion being parallel to the signal conductor with the gap, is less than or equal to 0.25 time a wavelength of a signal transmitted through the high-frequency transmission line.

An antenna according to an embodiment of the invention includes the above-described line conversion structure in which both end portions of the slot are closed, a lower dielectric layer, a lower ground layer, a first opening, a second opening, and a plurality of shield conductors. The lower dielectric layer is formed on the lower surface of the dielectric layer. The lower ground layer is formed on a lower surface of the lower dielectric layer. The first opening is formed in a portion of the ground layer that faces the slot. The second opening is formed in a portion of the lower ground layer that faces the slot. The plurality of shield conductors are configured to surround the first opening and the second opening in a plan view, and to connect the ground layer and the lower ground layer.

### Advantageous Effects of Invention

In the line conversion structure according to the embodiment of the invention, the signal conductor of the high-frequency transmission line is orthogonal to the slot ground conductor and the slot, with a gap between the signal conductor and the slot ground conductor, an end of the signal conductor is connected to the slot signal conductor, and the length of the portion of the slot ground conductor, the portion being parallel to the signal conductor with the gap, is less than or equal to 0.25 times the wavelength of the signal transmitted through the high-frequency transmission line. Accordingly, in the portion where the signal conductor is orthogonal to the slot ground conductor with a gap between the signal conductor and the slot ground conductor, no transition to a coplanar line transmission mode occurs, and the high-frequency transmission line can be converted directly into the slot line. This also produces no resonance, thus achieving a line conversion structure with a small loss in conversion.

As described above, the antenna according to the embodiment of the invention includes the line conversion structure of the above embodiment of the invention, in which both end portions of the slot are closed, the lower dielectric layer, the lower ground layer, the first opening, the second opening, and the plurality of shield conductors. Thus, with such an antenna, signals that have been transmitted through the high-frequency transmission line are stored efficiently in the slot line as signal energy, and of the lower dielectric layer disposed on the underside of the slot, a portion that is surrounded by the shield conductors functions as a dielectric matching unit that achieves high-frequency matching between the slot and a space located on the underside of the lower dielectric layer. Accordingly, it is possible to emit signals through the first opening and the second opening to the space with a small loss (high efficiency).

### BRIEF DESCRIPTION OF DRAWINGS

Other and further objects, features, and advantages of the invention will be more explicit from the following detailed description taken with reference to the drawings wherein:

FIG. 1A is a schematic perspective view for illustrating an example of a line conversion structure according to an embodiment of the invention;

FIG. 1B is a schematic plan view for illustrating an example of the line conversion structure according to the embodiment of the invention;

FIG. 1C is a schematic cross-sectional view taken along the line A-A indicated in FIG. 1A for illustrating an example of the line conversion structure according to the embodiment of the invention;

FIG. 1D is a schematic cross-sectional view taken along the line B-B indicated in FIG. 1A for illustrating an example of the line conversion structure according to the embodiment of the invention;

FIG. 2A is a schematic perspective view for illustrating another example of the line conversion structure according to the embodiment of the invention;

FIG. 2B is a schematic plan view for illustrating another example of the line conversion structure according to the embodiment of the invention;

FIG. 20 is a schematic cross-sectional view taken along the line A-A indicated in FIG. 2A for illustrating another example of the line conversion structure according to the embodiment of the invention;

FIG. 3A is a schematic perspective view for illustrating still another example of the line conversion structure according to the embodiment of the invention;

FIG. 3B is a schematic plan view for illustrating still another example of the line conversion structure according to the embodiment of the invention;

FIG. 3C is a schematic cross-sectional view taken along the line A-A indicated in FIG. 3B for illustrating still another example of the line conversion structure according to the embodiment of the invention;

FIG. 4A is a schematic perspective view for illustrating still another example of the line conversion structure according to the embodiment of the invention;

FIG. 4B a schematic plan view for illustrating still another example of the line conversion structure according to the embodiment of the invention;

FIG. 4C a schematic cross-sectional view taken along the line A-A indicated in FIG. 4A for illustrating still another example of the line conversion structure according to the embodiment of the invention;

FIG. 5A is a schematic plan view for illustrating still another example of the line conversion structure according to the embodiment of the invention;

FIG. 5B is a schematic cross-sectional view taken along the line A-A indicated in FIG. 5A for illustrating still another example of the line conversion structure according to the embodiment of the invention;

FIG. 5C is a schematic cross-sectional view taken along the line B-B indicated in FIG. 5A for illustrating still another example of the line conversion structure according to the embodiment of the invention;

FIG. 6A is a schematic plan view for illustrating an example of an antenna according to an embodiment of the invention;

FIG. 6B is a schematic cross-sectional view taken along the line A-A indicated in FIG. 6A for illustrating an example of the antenna according to the embodiment of the invention;

FIG. 6C is a schematic bottom view for illustrating an example of an antenna according to the embodiment of the invention;

FIG. 7A is a schematic plan view for illustrating another example of the antenna according to the embodiment of the invention;

FIG. 7B is a schematic cross-sectional view taken along the line A-A indicated in FIG. 7A for illustrating another example of the antenna according to the embodiment of the invention;

FIG. 7C is a schematic cross-sectional view taken along the line B-B indicated in FIG. 7A;

FIG. 8 is a graph showing a frequency characteristic of a loss caused between a microstrip line and an output microstrip line, as a result of simulations for verifying an effect of the line conversion structure of the embodiment;

FIG. 9 is a graph showing a relationship between a loss and a length of a portion of the slot ground conductor which portion is parallel to a signal conductor with a gap in between, as a result of simulations for verifying an effect of the line conversion structure of the embodiment;

FIG. 10 is a graph showing a relationship between a loss and a distance between the signal conductor and the through conductor, as a result of simulations for verifying an effect of the line conversion structure of the embodiment.

FIG. 11 is a graph showing simulation results for a reflection of the antenna of the embodiment.

FIG. 12 is a graph showing the relationship between a gain of the antenna and a slot pattern width in a case where no ground-reinforcing conductors are formed;

FIG. 13A is a graph showing a simulation result for a gain of the antenna in Test Cases 1;

FIG. 13B is a graph showing a simulation result for a gain of the antenna in Test Cases 3;

FIG. 13C is a graph showing a simulation result for a gain of the antenna in Test Cases 5;

FIG. 14 is a graph showing a relationship between a gain of the antenna and a clearance between ground-reinforcing conductors and end portions of the slot;

FIG. 15A is a graph showing a simulation result for a gain of the antenna in Test Cases 6;

FIG. 15B is a graph showing a simulation result for a gain of the antenna in Test Cases 7;

FIG. 15C is a graph showing a simulation result for a gain of the antenna in Test Cases 8; and

FIG. 16 is a graph showing a simulation result for a gain of the antenna in Test Case 11.

### DESCRIPTION OF EMBODIMENTS

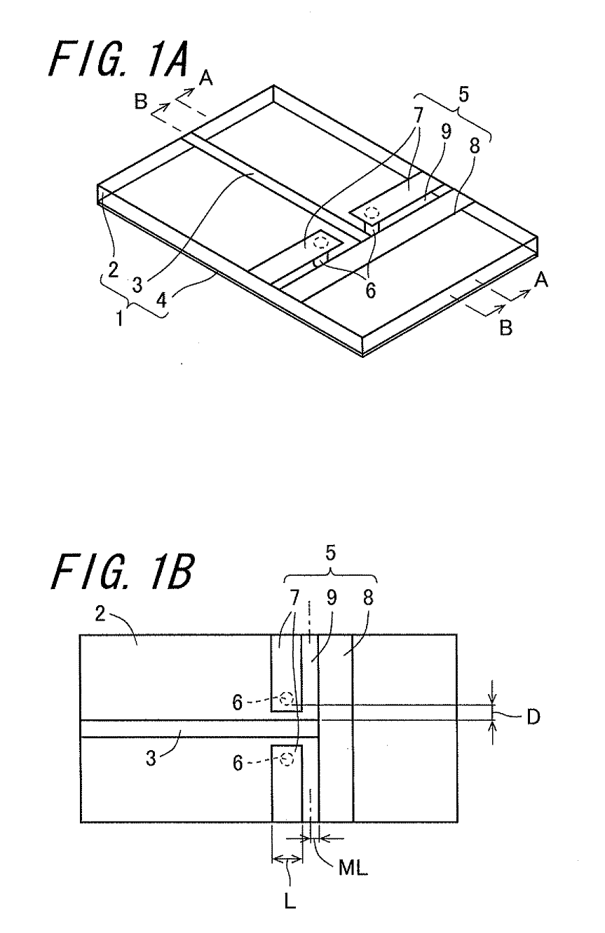

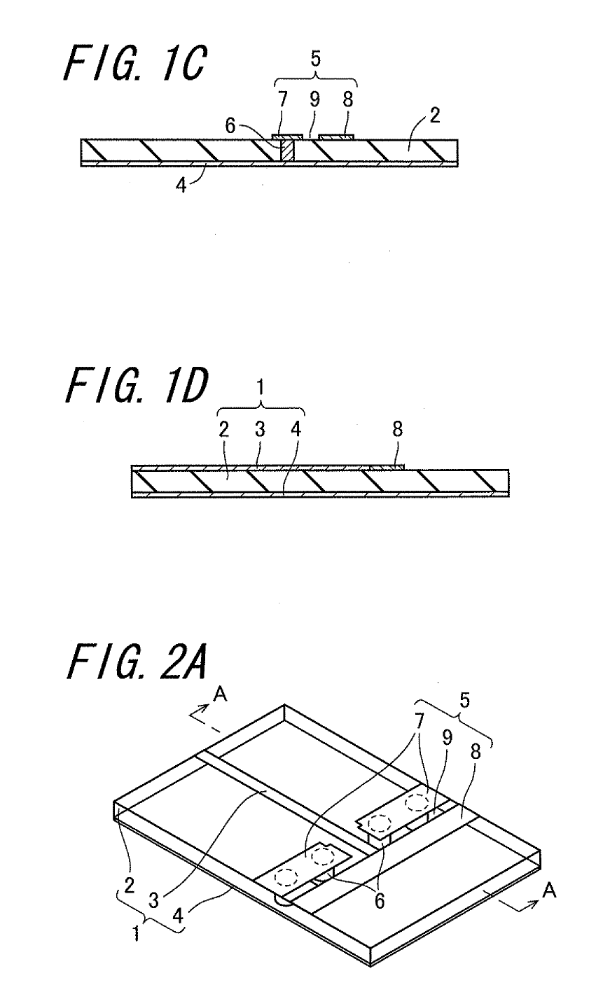

Hereinafter, an embodiment of a line conversion structure according to the invention will be described in detail with reference to the attached drawings. A microstrip line 1 serving as a high-frequency transmission line, a dielectric layer 2, a lower dielectric layer 2a, a signal conductor 3, a ground layer 4, a first opening 4a, a slot line 5, through conductors 6, ground-reinforcing conductors 6a, upper ground-reinforcing conductors 6b, a slot ground conductor 7, a slot signal conductor 8, a slot 9, a slot pattern conductor 9a, an upper dielectric layer 10 or 16, an upper ground layer 11 or 17, an output signal conductor 12, an output microstrip line 13, and a strip line 18 serving as a high-frequency transmission line are shown in FIGS. 1A to 1D, 2A to 2C, 3A to 3C, 4A to 4C, and 5A to 5C. Note that, for easier understanding of the structure, the dielectric layer 2, the lower dielectric layer 2a, and the upper dielectric layer 10 or 16 are shown in a see-through manner in FIGS. 1A to 5C. The dashed dotted line in FIG. 1B indicates a center line of the slot 9 in the widthwise direction.

FIGS. 1A to 1D are schematic diagrams for illustrating an example of the line conversion structure according to the embodiment of the invention, FIG. 1A being a perspective view, FIG. 1B being a plan view, FIG. 1C being a cross-sectional view taken along the line A-A indicated in FIG. 1A, and FIG. 1D being a cross-sectional view taken along the line B-B indicated in FIG. 1A. In a line conversion structure of the embodiment in which the microstrip line 1 serving as a high-frequency transmission line is converted into the slot line 5, the microstrip line 1 includes the dielectric layer 2, the signal conductor 3 disposed on an upper surface of the dielectric layer 2, and the ground layer 4 disposed on a lower surface of the dielectric layer 2 as in the example shown in FIGS. 1A to 1D. The slot line 5 includes the slot ground conductor 7, the slot signal conductor 8, and the slot 9. The slot ground conductor 7 is disposed on the upper surface of the dielectric layer 2 and connected to the ground layer 4 with the through conductors 6 that pass through the dielectric layer 2. The slot signal conductor 8 is disposed on the upper surface of the dielectric layer 2. The slot 9 is disposed between the slot ground conductor 7 and the slot signal conductor 8. The signal conductor 3 of the microstrip line 1 is orthogonal to the slot ground conductor 7 and the slot 9, with a gap between the signal conductor 3 and the slot ground conductor 7, and one end of the signal conductor 3 is connected to the slot signal conductor 8. With such a configuration, since the signal conductor 3 and the slot 9 are formed on the same dielectric layer 2, a stub length (which is indicated by ML in FIG. 1B, and in the example, half the width of the slot 9) that is a factor of the characteristic of conversion to the slot line 5 is not affected by a shift in print position and layer-to-layer misalignment during manufacture and depends only on the variation in print dimensions. As a result, the variation in the stub length is reduced and the variation in the characteristic of conversion from the microstrip line 1 to the slot line 5 is reduced. The length of a portion of the slot ground conductor 7 (indicated by L in FIG. 1B), the portion being parallel to the signal conductor 3 with a gap, is less than or equal to 0.25 times the wavelength of signals transmitted through the microstrip line 1. Accordingly, in a portion where the signal conductor 3 is orthogonal to the slot ground conductor 7 with a gap between the signal conductor 3 and the slot ground conductor 7, no transition to a coplanar line transmission mode occurs, and the microstrip line 1 can be converted directly into the slot line 5. This also produces no resonance, thus achieving a line conversion structure with a small loss in conversion.

Furthermore, with the configuration described above, if a distance (indicated by D in FIG. 1B) between the signal conductor 3 and a through conductor 6 that is located closest to the portion of the slot ground conductor 7, the portion being parallel to the signal conductor 3 with a gap in between, is less than or equal to 0.13 times the wavelength of signals transmitted through the microstrip line 1, the distance from the ground layer 4 located immediately under the signal conductor 3 of the microstrip line 1 via that through conductor 6 to the slot ground conductor 7 is sufficiently short. This allows the ground potential of the microstrip line 1 to be transmitted to the slot ground conductor 7 without delay, thus further reducing the loss in conversion from the microstrip line 1 to the slot line 5.

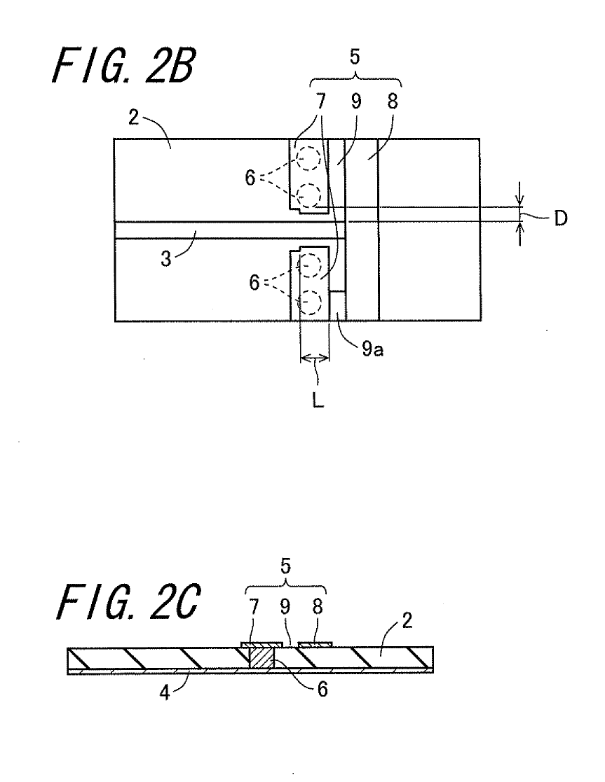

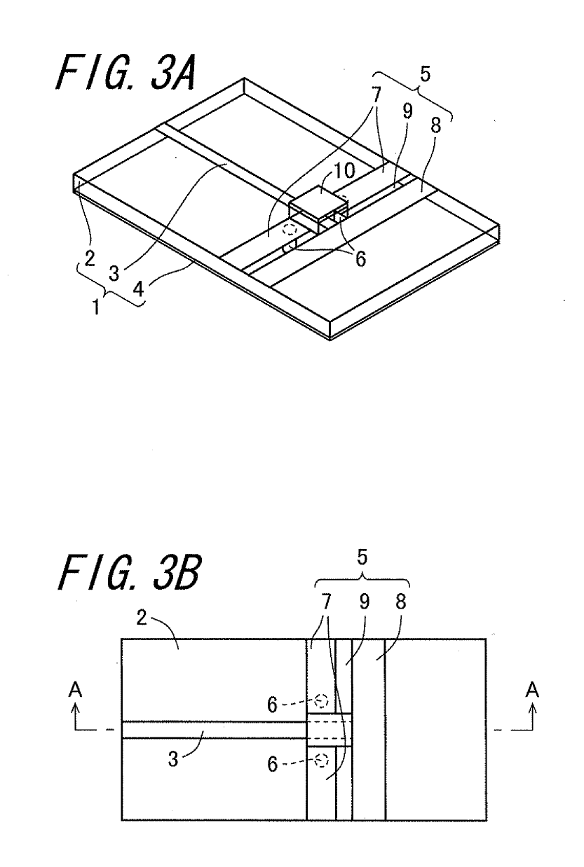

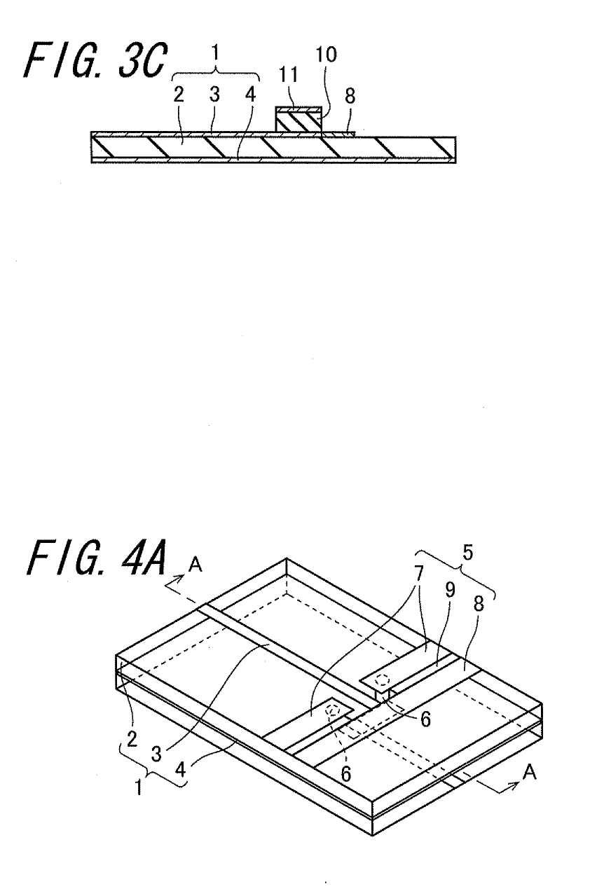

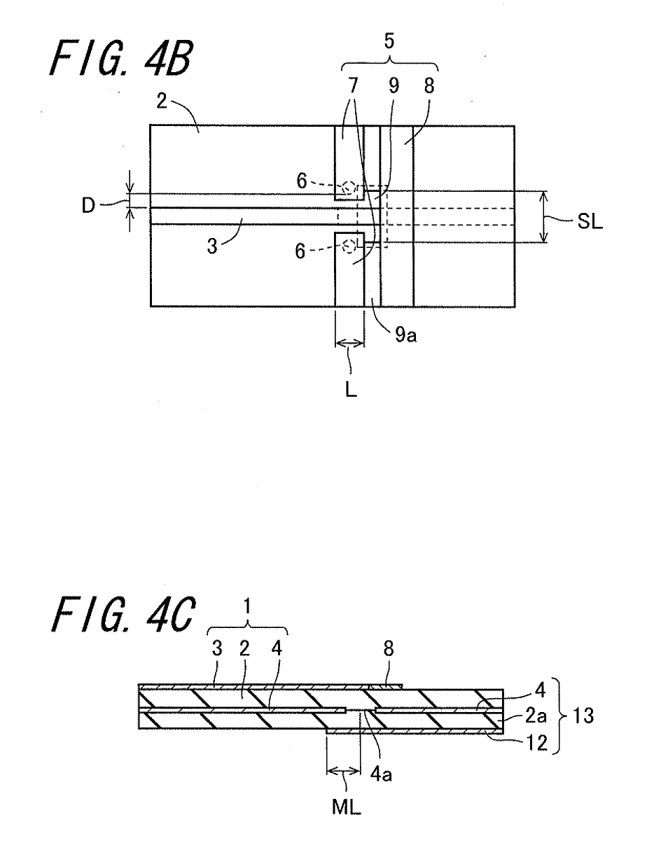

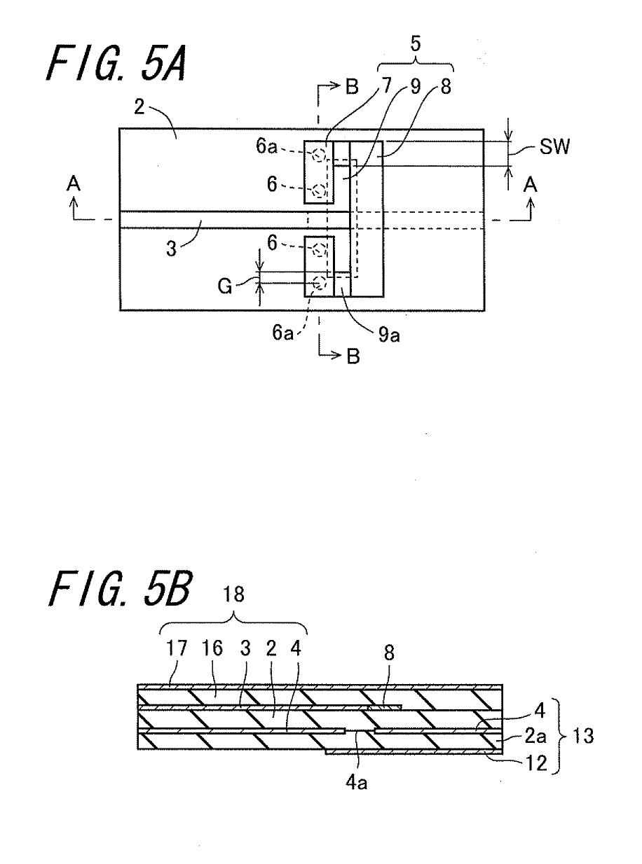

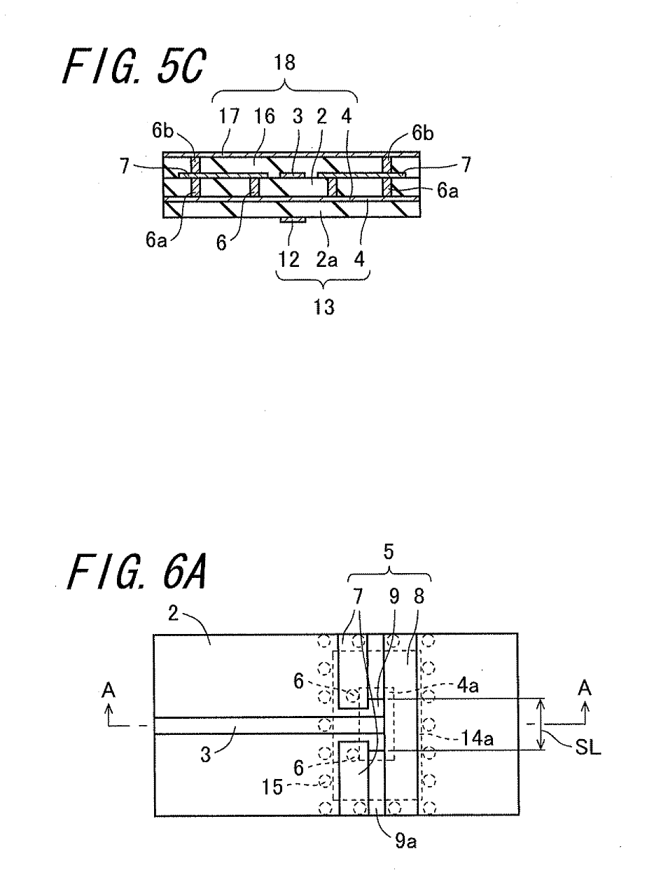

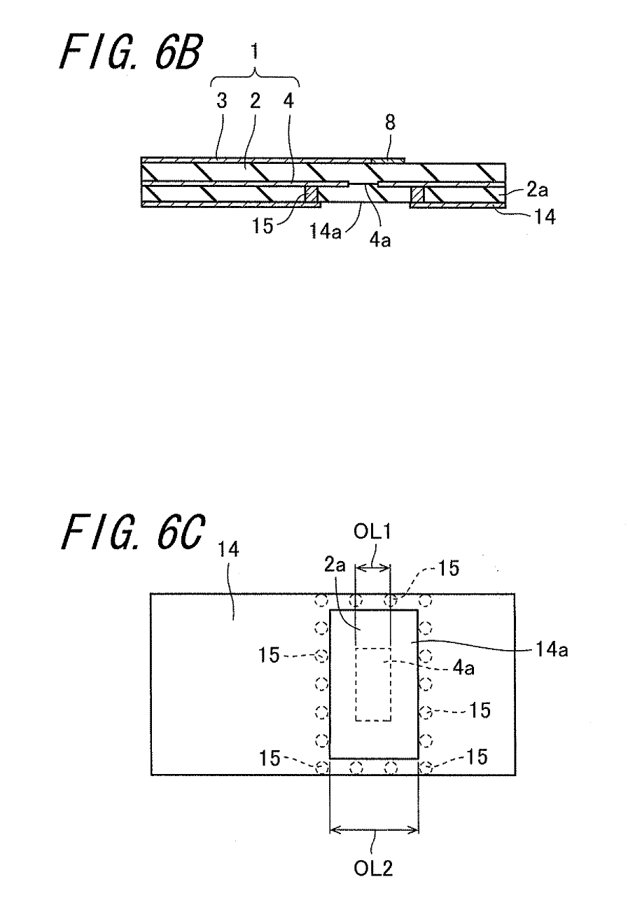

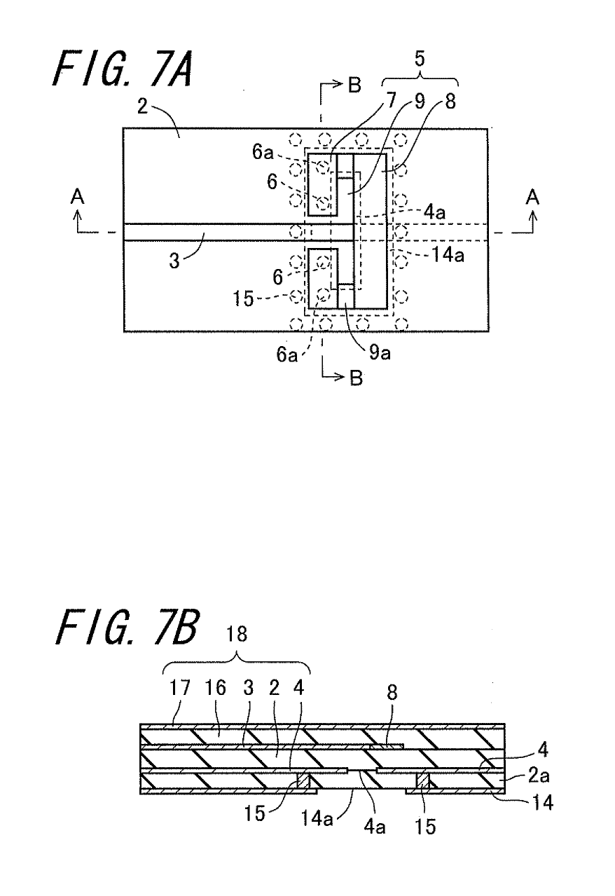

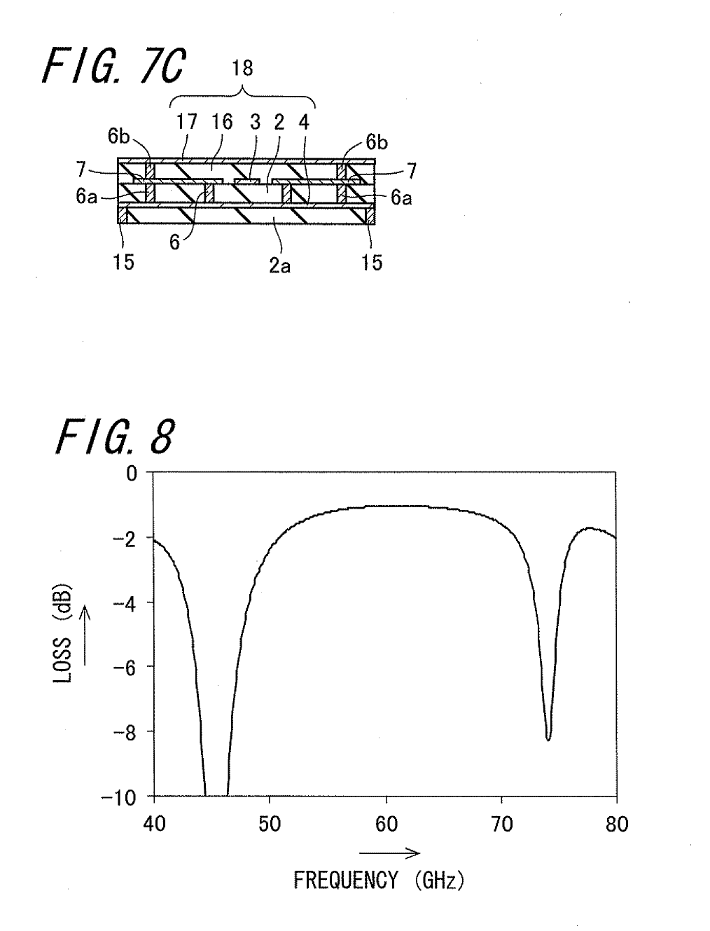

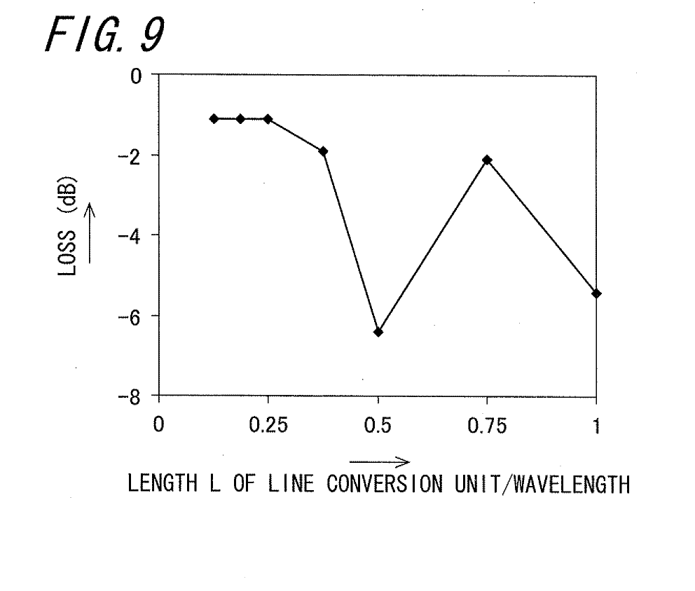

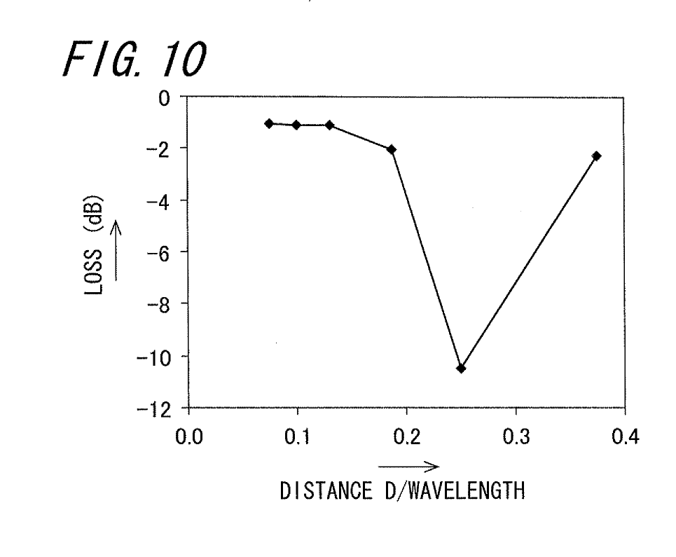

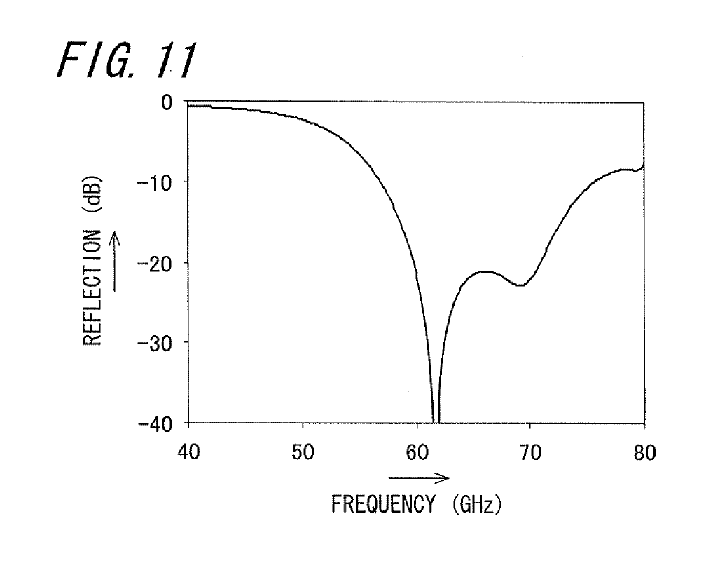

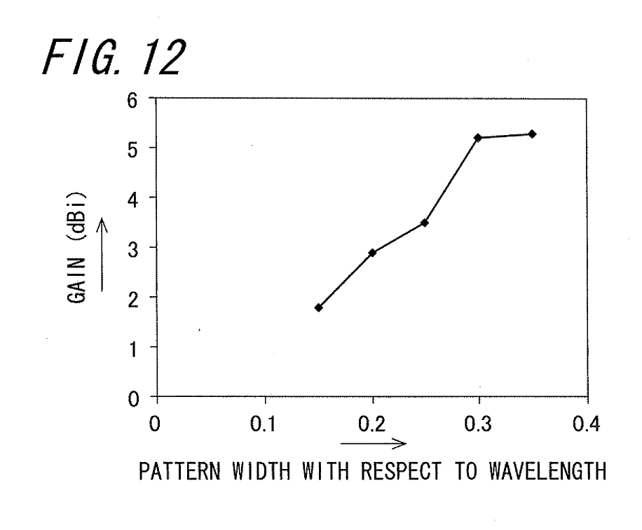

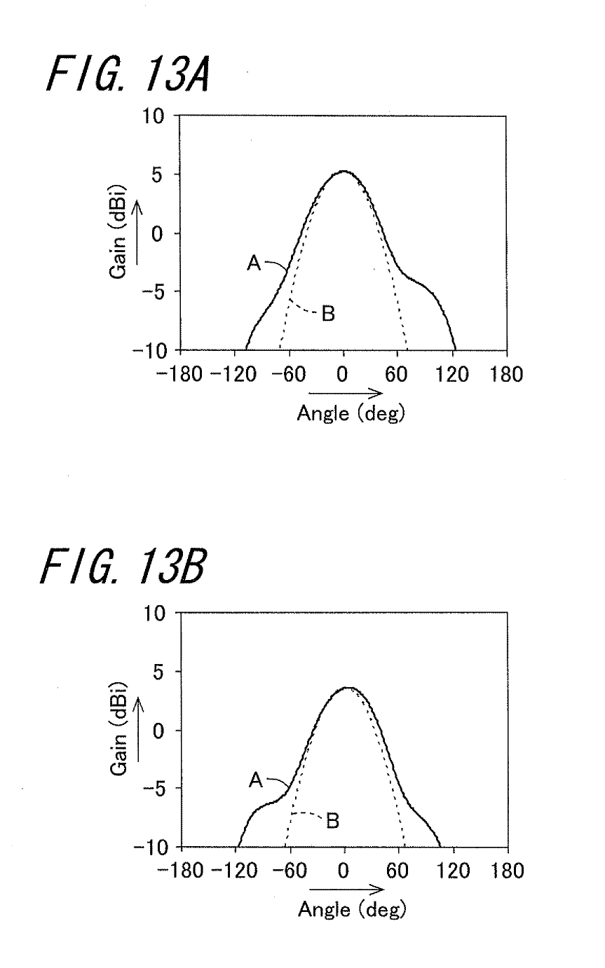

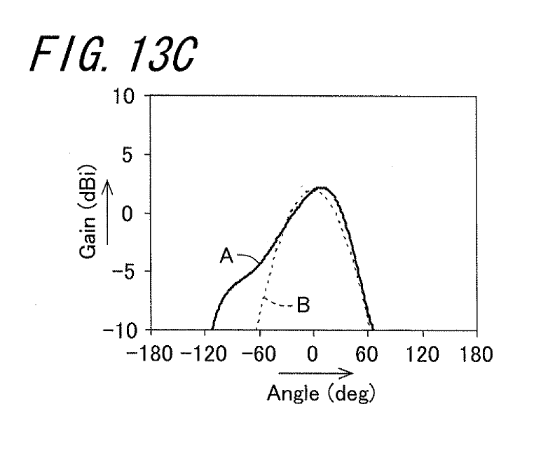

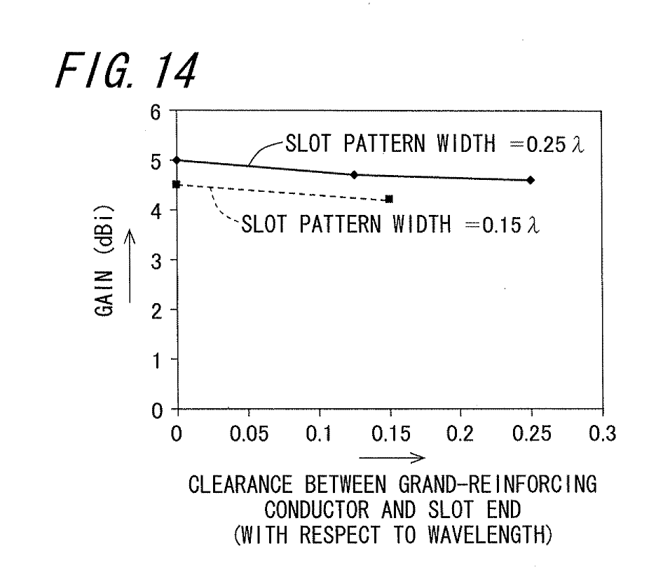

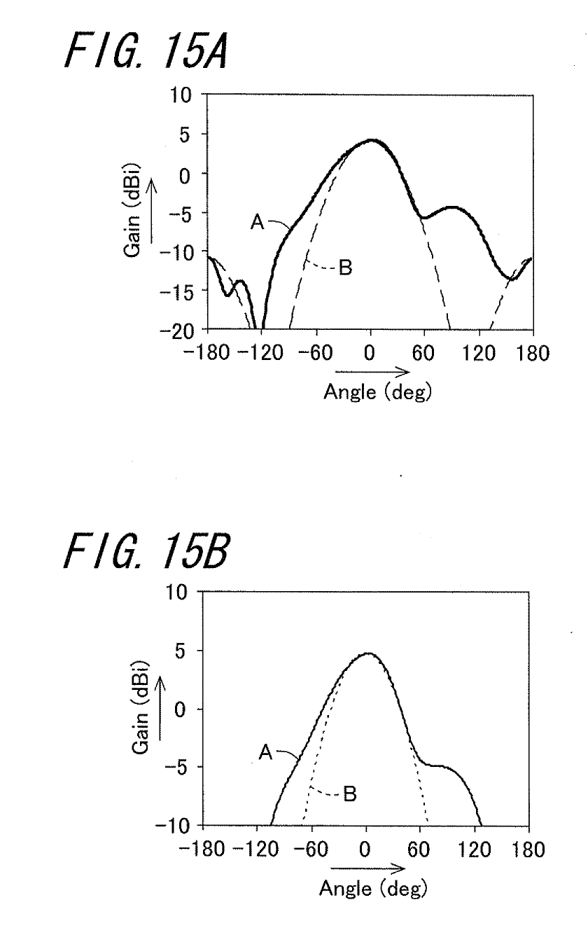

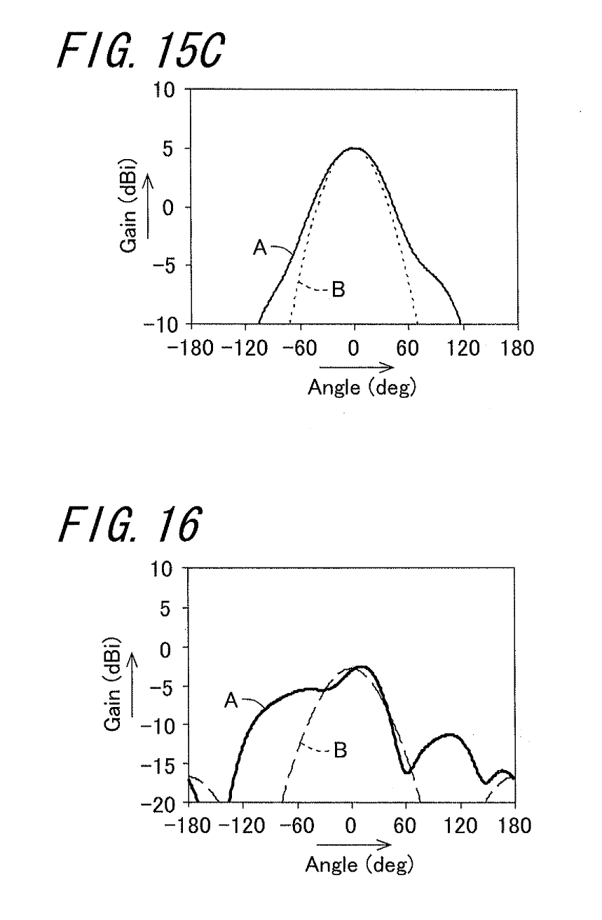

FIGS. 2A to 2C are schematic diagrams for illustrating another example of the line conversion structure according to the embodiment of the invention, FIG. 2A being a perspective view, FIG. 2B being a plan view, and FIG. 20 being a cross-sectional view taken along the line A-A indicated in FIG. 2A. In the example shown in FIGS. 2A to 2C, the slot ground conductor 7 has a greater width and the through conductors 6 that connect the slot ground conductor 7 and the ground layer 4 have a greater diameter than in the example shown in FIGS. 1A to 1D. This enables a delay in propagation of the ground potential due to the inductance of the through conductors 6 to be reduced when transmitting the ground potential of the microstrip line 1 to the slot ground conductor 7, thus reducing a delay in the ground potential of the slot ground conductor 7. Accordingly, the loss in conversion from the microstrip line 1 to the slot line 5 can be further reduced. Although such an effect is achieved by simply increasing the diameter of the through conductors 6, the through conductors 6 will extend beyond the slot ground conductor 7 and the end faces of the through conductors 6 will be exposed at the surface of the dielectric layer 2 in this case. As a result, in the process of manufacturing a wiring board or the process of implementing elements on a wiring board, there are cases, for example, where in a plating step or a cleaning step that is performed after implementation of elements, a liquid such as a plating solution or a cleaning solution enters from a slight gap between the through conductors 6 and the dielectric layer 2, resulting in an increase in conductivity resistance due to corrosion of the through conductors 6, or in a liquid drying step, cracks occur in the wiring board due to stress caused by liquid expansion or evaporation, resulting in disconnections or poor insulation. For this reason, it is preferable to make the width of the slot ground conductor 7 greater than the diameter of the through conductors 6. In this case, it is sufficient that a length L of only the portion of the slot ground conductor 7, the portion being parallel to the signal conductor 3 with a gap, is made less than or equal to 0.25 times the wavelength of signals transmitted through the microstrip line 1. Thus, as in the example shown in FIGS. 2A to 2C, the width of the portion of the slot ground conductor 7 which portion is farther from the gap is greater than the width of the portion of the slot ground conductor 7 which portion is parallel to the signal conductor 3 with the gap in between.

FIGS. 3A to 3C are schematic diagrams for illustrating still another example of the line conversion structure according to the embodiment of the invention, FIG. 3A being a perspective view, FIG. 3B being a plan view, and FIG. 3C being a cross-sectional view taken along the line A-A indicated in FIG. 3B. As in the example shown in FIGS. 3A to 3C, it is preferable in the line conversion structure of the embodiment that an upper ground layer 11 is formed via an upper dielectric layer 10 on the dielectric layer 2 so as to cover a portion of the signal line 3 which portion is orthogonal to the slot line 5 and a gap therebetween, as well as a portion of the slot line 5 between the gap and the slot signal conductor 8, that is, to cover a line conversion unit. Such a configuration enables the line conversion unit to be shielded from the outside, thus suppressing emission of signals from the conversion unit to the outside and incidence of noise from the outside to the line conversion unit. The line conversion unit in the line conversion structure of the embodiment is a portion where an electromagnetic field mode of signals transmitted through a microstrip line 1 is converted directly into an electromagnetic field mode of signals transmitted through the slot line 5. The electromagnetic field mode of that portion is thus more complex than the electromagnetic field mode of signals transmitted through a simple transmission line, and the line conversion unit has a structure susceptible to the influence of the emission to the outside or the incidence from the outside. Thus, covering the line conversion unit with the upper ground layer 11 achieves an effective reduction in the influence of the emission to the outside or the incidence from the outside.

Although the upper ground layer 11 is formed only over the line conversion unit in the example shown in FIGS. 3A to 3C, it is preferable that the upper ground layer 11 to be formed is larger than the line conversion unit in a plan view because this further enhances the above-described shield effect, and in the case of creating a wiring board or the like that includes the line conversion structure of the embodiment, allows the line conversion unit to be reliably covered even if there is somewhat of a shift in the position of the upper ground layer 11. Furthermore, if the entire upper surface of the dielectric layer 2 is covered with the upper ground layer 11 via the upper dielectric layer 10, the line conversion unit is completely shielded from above and below by the upper ground layer 11 located above and the ground layer 4 located below. This completely suppresses the emission to the outside or the incidence from the outside in the vertical direction, and also makes it easy to form the upper dielectric layer 10 in the case of creating a wiring board or the like that includes the line conversion structure of the embodiment using a green sheet lamination method.

Furthermore, as in the example shown in FIGS. 2A to 2C, multiple through conductors 6 may be provided in a line in the lengthwise direction of a slot ground conductor 7 (in a direction away from the gap). By doing so, it is possible to allow the through conductors 6 to pass through the dielectric layer 2, and thus suppress the incidence of noise from the outside to a slot 9 and the line conversion unit.

If a slot pattern conductor 9a is disposed on the upper surface of the dielectric layer 2 so as to close at least one end portion of the slot 9, it is possible to change the direction of signal transmission to the desired direction. For example, if the slot pattern conductor 9a is disposed so as to close only one end portion of the slot 9 as in the example shown in FIGS. 2A to 2C, signals will be totally reflected at that closed end portion and transmitted to the other end portion of the slot 9. Thus, signals transmitted through the microstrip line 1 can be transmitted toward the desired one end portion of the slot 9.

FIGS. 4A to 4C are schematic diagrams for illustrating still another example of the line conversion structure according to the embodiment of the invention, FIG. 4A being a perspective view, FIG. 4B being a plan view, and FIG. 4C being a cross-sectional view taken along the line A-A indicated in FIG. 4A. If two slot pattern conductors 9a are disposed so as to close both end portions of a slot 9 as in the example shown in FIGS. 4A to 4C, signals transmitted through a microstrip line 1 are temporarily stored in a slot line 5 as energy and transmitted, for example through a first opening 4a of a ground layer 4 formed on a lower surface of a dielectric layer 2, to another transmission line such as an output microstrip line 13 configured by the ground layer 4, a lower dielectric layer 2a formed therebelow, and an output signal conductor 12 formed on a lower surface of the lower dielectric layer 2a, or to an antenna, a waveguide, or the like that is disposed in a direction vertical to the slot. Thus, signals can be transmitted via the slot line 5 to an external element with electromagnetic coupling.

FIGS. 5A to 5C are schematic diagrams for illustrating still another example of the line conversion structure according to the embodiment of the invention, FIG. 5A being a plan view, FIG. 5B being a cross-sectional view taken along the line A-A indicated in FIG. 5A, and FIG. 5C being a cross-sectional view taken along the line B-B indicated in FIG. 5A. In the line conversion structure in the example shown in FIGS. 5A to 5C, a strip line 18 serving as a high-frequency transmission line is converted into a slot line 5. In the example shown in FIGS. 5A to 5C, the strip line 18 includes an upper dielectric layer 16, an upper ground layer 17 disposed on an upper surface of the upper dielectric layer 16, a dielectric layer 2, a signal conductor 3 disposed on an upper surface of the dielectric layer 2, and a ground layer 4 disposed on a lower surface of the dielectric layer 2. The slot line 5 includes a slot ground conductor 7, a slot signal conductor 8, and a slot 9. The slot ground conductor 7 is disposed on the upper surface of the dielectric layer 2 and connected to the ground layer 4 with through conductors 6 that pass through the dielectric layer 2. The slot signal conductor 8 is disposed on the upper surface of the dielectric layer 2. The slot 9 is disposed between the slot ground conductor 7 and the slot signal conductor 8. The signal conductor 3 of the strip line 18 is orthogonal to the slot ground conductor 7 and the slot 9, with a gap provided between the signal conductor 3 and the slot ground conductor 7, and the end of the signal conductor 3 is connected to the slot signal conductor 8.

In the line conversion structure in the example shown in FIGS. 5A to 5C, two slot pattern conductors 9a are disposed on the upper surface of the dielectric layer 2 so as to close both end portions of the slot 9. The length of a portion of each slot pattern conductor 9a, the portion being perpendicular to the signal conductor 3 (slot pattern width SW), is less than or equal to 0.25 times the wavelength of signals transmitted through the strip line 18. In the case where the length of the portion of each slot pattern conductor 9a, the portion being perpendicular to the signal conductor 3 (slot pattern width SW), is short in this way, a ground-reinforcing conductor 6a that passes through the dielectric layer 2 and connects the slot ground conductor 7 and the ground layer 4 is formed in a region that extends from each end portion of the slot 9 in a direction away from the signal conductor 3 and ranges within 0.25 times the wavelength of signals transmitted through the strip line 18. In other words, the ground-reinforcing conductors 6a are provided such that clearance G between the ground-reinforcing conductors 6a and the ends of the slot 9 is less than or equal to 0.25 times the wavelength of signals transmitted through the strip line 18. This enables the potential at the end portions of the slot 9 on the slot ground conductor 7 side to be close to the ground potential. Resultant short circuiting of the potential of the slot signal conductor 8 and the ground potential of the slot ground conductor 7 at the end portions of the slot 9 makes symmetrical the distributions of currents flowing through the respective conductors and accordingly makes symmetrical the electromagnetic fields that depend on the current distributions. This enables suppression of unnecessary signal emissions, thus suppressing a reduction in gain in the case where the line conversion structure is used in an antenna.

Furthermore, in the line conversion structure in the example shown in FIGS. 5A to 5C in which the strip line 18 includes the upper ground layer 17, the upper ground layer 17 enables suppression of signal emissions from above to the outside, thus suppressing a reduction in gain in the case where the line conversion structure is used in an antenna.

Furthermore, in the above-described configuration, it is preferable that there is provided upper ground-reinforcing conductors 6b that pass through the upper dielectric layer 16 and connect the slot ground conductor 7 and the upper ground layer 17. The provision of the upper ground-reinforcing conductors 6b in this way enables the potential at the end portions of the slot 9 on the slot ground conductor 7 side to be closer to the ground potential, thus further suppressing a reduction in gain.

Furthermore, if the two slot pattern conductors 9a are disposed so as to close both end portions of the slot 9 as in the example shown in FIGS. 5A to 5C, signals transmitted through the strip line 18 are temporarily stored in the slot line 5 as energy and transmitted, for example through a first opening 4a of the ground layer 4 formed on the lower surface of the dielectric layer 2, to another transmission line such as an output microstrip line 13 configured by the ground layer 4, a lower dielectric layer 2a formed therebelow, and an output signal conductor 12 formed on the lower surface of the lower dielectric layer 2a, or to an antenna, a waveguide, or the like that is disposed in a direction vertical to the slot 9. Thus, signals can be transmitted via the slot line 5 to an external element with electromagnetic coupling.

By using the line conversion structure of the embodiment with such a configuration, a low-loss antenna can be configured.

FIGS. 6A to 6C are schematic diagrams for illustrating an example of an antenna according to an embodiment of the invention, FIG. 6A being a plan view, FIG. 6B being a cross-sectional view taken along the line A-A indicated in FIG. 6A, and FIG. 60 being a bottom view. A lower ground layer 14, a second opening 14a formed in the lower ground layer 14, and shield conductors 15 are shown in FIGS. 6A to 6C, and other reference numerals denote components that are the same as those shown in FIGS. 1A to 5C. For easer understanding of the structure, the dielectric layer 2 and the lower dielectric layer 2a are shown in a see-through manner in FIGS. 6A to 6C, as in FIGS. 1A to 50.

The antenna in the example shown in FIGS. 6A to 6C includes a line conversion structure having one of the configurations shown in FIGS. 1A to 4C, in which both end portions of the slot 9 are closed, the lower dielectric layer 2a, the lower ground layer 14, the first opening 4a, the second opening 14a, and the plurality of shield conductors 15. The lower dielectric layer 2a is formed on the lower surface of the dielectric layer 2. The lower ground layer 14 is formed on the lower surface of the lower dielectric layer 2a. The first opening 4a is formed in a portion of the ground layer 4 that faces the slot 9. The second opening 14a is formed in a portion of the lower ground layer 14 that faces the slot 9. The plurality of shield conductors 15 are configured to surround the first opening 4a and the second opening 14a in a plan view, and connect the ground layer 4 and the lower ground layer 14. With the antenna configured in this way, signals transmitted through the microstrip line 1 is efficiently stored in the slot line 5 as signal energy, and out of the lower dielectric layer 2a that is disposed on the underside of the slot 9, the portion surrounded by the shield conductors 15 functions as a dielectric matching unit that achieves high-frequency matching between the slot 9 and a space below the lower dielectric layer 2a. It is thus possible to emit signals through the first opening 4a and the second opening 14a into the space with a small loss (high efficiency).

If the line conversion structure provided in the antenna has a lower-loss structure as described above, the antenna will also achieve a smaller loss (higher efficiency). In the line conversion structure, a loss in conversion from the microstrip line 1 to the slot line 5 is further reduced if the length (indicated by in FIG. 1B) of a portion of the slot ground conductor 7, the portion being parallel to the signal conductor 3 with a gap, is less than or equal to 0.25 times the wavelength of signals transmitted through the microstrip line 1 and if the distance (indicated by D in FIG. 1B) between the signal conductor 3 and the through conductor 6 that is located closest to the portion of the slot ground conductor 7 which portion is parallel to the signal conductor 3 with a gap is less than or equal to 0.13 times the wavelength of signals transmitted through the microstrip line 1. Accordingly, the antenna with such a configuration can efficiently emit high-frequency signals. Furthermore, with the antenna in the example shown in FIGS. 6A to 6C, if an upper ground layer 11 is formed on the dielectric layer 2 via the upper dielectric layer 10 so as to cover a portion of the signal conductor 3, the portion being orthogonal to the slot line 5, the gap, and a portion of the slot line 5 between the gap and the slot signal conductor 8, that is, to cover the line conversion unit, as in the example shown in FIGS. 3A to 3C, it is possible to shield the line conversion unit from the outside. This enables suppression of the emission of signals from the line conversion unit to the outside and the incidence of noise from the outside to the line conversion unit. Accordingly, the antenna with such a configuration will be a lower-loss (more highly efficient) antenna, or a noise-resistant antenna.

Furthermore, in the above-described configuration of the antenna of the embodiment, if the first opening 4a has a shorter length than the second opening 14a in the direction parallel to the signal conductor 3 as in the example shown in FIGS. 6A to 6C, a portion of the ground layer 4 that overlaps the second opening 14a serves to suppress leakage of a disturbed electromagnetic field mode in the line conversion unit into a region (dielectric matching unit) surrounded by the plurality of shield conductors 15. Accordingly, the antenna with such a configuration is a more highly efficient antenna that is capable of suppressing the occurrence of unnecessary resonance in the dielectric matching unit due to a disturbed electromagnetic field mode.

The thickness of the lower dielectric layer 2a is set to one fourth the wavelength of signals in the lower dielectric layer 2a, so that the portion of the lower dielectric layer 2a that is surrounded by the shield conductors 15 functions as a dielectric matching unit that achieves impedance matching between the slot 9 and a space below the lower dielectric layer 2a into which signals are to be emitted. Since the wavelength of signals in the lower dielectric layer 2a varies depending on the frequency of signals transmitted through the microstrip line 1 and the effective dielectric constant of the lower dielectric layer 2a, the thickness of the lower dielectric layer 2a is set in accordance therewith.

The plurality of shield conductors 15 are formed in the lower dielectric layer 2a and arranged so as to surround the first opening 4a and the second opening 14a in a plan view. Each of the shield conductors 15 connects the ground layer 4 and the lower ground layer 14. The shield conductors 15 are preferably arranged in close proximity outside the second opening. Since signals that have passed through the first opening 4a pass through the portion surrounded by the shield conductors 15, if a portion of the lower ground layer 14 that is located inside the shield conductors 15 is made smaller, it is possible to suppress interference with signal emissions in that portion. More preferably, the shield conductors 15 may be arranged adjacently outside the second opening 14a. In this case, the lower ground layer 14 will not interfere with signal emissions because there is almost no lower ground layer 14 inside the shield conductors 15.

The distances between the plurality of shield conductors 15 are preferably less than or equal to one fourth the wavelength of signals transmitted through the dielectric matching unit, so as to avoid leakage of high-frequency signals from the gaps between the adjacent shield conductors 15.

The slot 9, the first opening 4a, and the second opening 14a are disposed so as to face one another, i.e., to overlap one another in a plan view. In order to prevent the ground layer 4 from interfering with signal emissions from the slot 9 to the lower dielectric layer 2a, the first opening 4a is larger than the slot 9, and the first opening 4a and the slot 9 are disposed so as to make their centers coincide. Also, in order to prevent the lower ground layer 14 from interfering with emissions of signals, which have passed through the first opening 4a, into the space below the lower dielectric layer 2a, the second opening 14a is larger than the first opening 4a, and the first opening 4a and the second opening 14a are disposed so as to make their centers coincide. Such dimensions and disposition of the slot 9, the first opening 4a, and the second opening 14a enable signals to be favorably emitted from the slot 9 through the first opening 4a and the second opening 14a into the space thereunder.

In terms of the size relationship between the first opening 4a and the second opening 14a, it is in particular preferable, as mentioned above, that the first opening 4a has a shorter length than the second opening 14a in the direction parallel to the signal conductor 3. By doing so, it is possible to suppress the occurrence of a magnetic field of unnecessary resonance in the dielectric matching unit as a result of excitation caused by a magnetic field occurring around the signal conductor 3, in particular, a disturbed magnetic field occurring in a portion of the signal conductor 3 that is sandwiched by the slot ground conductor 7 and in which signals are to be converted. A magnetic field of unnecessary resonance in the dielectric matching unit is likely to occur along the outer periphery of the dielectric matching unit (a region close to the shield conductors 15), and a magnetic field of unnecessary resonance occurs as a result of excitation caused by a magnetic field occurring around the signal conductor 3, that is, a magnetic field occurring in a direction perpendicular to the signal conductor 3 in a plan view. For this reason, a magnetic field of unnecessary resonance is likely to occur in a portion on the outer periphery of the dielectric matching unit that extends in the direction perpendicular to the signal conductor 3. If the first opening 4a has a shorter length than the second opening 14a in the direction parallel to the signal conductor 3, the ground layer 4 is between the portion where a magnetic field of unnecessary resonance is likely to occur and the signal conductor 3, and the ground layer 4 can serve as a shield against a magnetic field occurring around the signal conductor 3. It is thus possible to suppress the occurrence of a magnetic field of unnecessary resonance. Since a magnetic field of unnecessary resonance is likely to concentrate in a region that ranges within one fourth the distance between the shield conductors 15 and the center of the dielectric matching unit from the shield conductors 15, it is preferable that the length of the first opening 4a in the direction parallel to the signal conductor 3 (indicated by OL1 in FIG. 6C) is shorter than half the length of the second opening 14a in the direction parallel to the signal conductor 3 (indicated by OL2 in FIG. 6C). If, as mentioned above, the first opening 4a and the second opening 14a are disposed so as to make their centers coincide, and the length OL1 of the first opening 4a in the direction parallel to the signal conductor 3 is made shorter than half the length OL2 of the second opening 14a in the direction parallel to the signal conductor 3, a portion of the ground layer 4 around the first opening 4a is located on the region where a magnetic field of unnecessary resonance is likely to concentrate in the dielectric matching unit. This portion serves as an effective shield against a magnetic field occurring around the signal conductor 3, thus improving the effect of suppressing the occurrence of unnecessary resonance in the dielectric matching unit.

FIGS. 7A to 7C are schematic diagrams for illustrating another example of the antenna according to the embodiment of the invention, FIG. 7A being a plan view, FIG. 7B being a cross-sectional view taken along the line A-A indicated in FIG. 7A, and FIG. 7C being a cross-sectional view taken along the line B-B indicated in FIG. 7A. For easier understanding of the structure, the dielectric layer 2, the lower dielectric layer 2a, and the upper dielectric layer 16 are shown in a see-through manner in FIGS. 7A to 7C, as in FIGS. 1A to 6C. The antenna in the example shown in FIGS. 7A to 7C is configured in the same manner as the antenna shown in FIGS. 6A to 6C, with the exception that the line conversion structure shown in FIGS. 5A to 5C is used as a line conversion structure. Specifically, the antenna in the example shown in FIGS. 7A to 7C includes the line conversion structure shown in FIGS. 5A to 5C in which both end portions of the slot 9 are closed, the lower dielectric layer 2a, the lower ground layer 14, the first opening 4a, the second opening 14a, and the plurality of shield conductors 15. The lower dielectric layer 2a is formed on the lower surface of the dielectric layer 2. The lower ground layer 14 is formed on the lower surface of the lower dielectric layer 2a. The first opening 4a is formed in a portion of the ground layer 4 that faces the slot 9. The second opening 14a is formed in a portion of the lower ground layer 14 that faces the slot 9. The plurality of shield conductors 15 are arranged so as to surround the first opening 4a and the second opening 14a in a plan view, and connect the ground layer 4 and the lower ground layer 14. With the antenna configured in this way, signals transmitted through the strip line 18 are efficiently stored in the slot line 5 as signal energy, and out of the lower dielectric layer 2a disposed on the underside of the slot 9, the portion surrounded by the shield conductors 15 functions as a dielectric matching unit that achieves high-frequency matching between the slot 9 and the space located below the lower dielectric layer 2a. It is thus possible to emit signals through the first opening 4a and the second opening 14a into the space with a small loss (high efficiency). Furthermore, if the line conversion structure provided in the antenna is a structure as described above that is capable of suppressing a loss, the antenna can also suppress a reduction in gain.

The dielectric layer 2, the upper dielectric layer 10 or 16, and the lower dielectric layer 2a are made of ceramics, an organic resin, or a composite of these two. Examples of the ceramics include ceramic materials such as an alumina (Al₂O₃) sintered compact, an aluminum nitride (AlN) sintered compact, and a silicon nitride (Si₃N₄) sintered compact, glass materials, and glass ceramic materials made of a complex of glass and an inorganic filler such as Al₂O₃, SiO₂, or MgO. Examples of the organic resins include fluorocarbon resins such as tetrafluoroethylene resins (polytetrafluoroethylene (PTFE)), ethylene-tetrafluoroethylene copolymer resins (ethylene-tetrafluoroethylene copolymer resin (ETFE)), and tetrafluoroethylene-perfluoroalkoxy ethylene copolymer resins (tetrafluoroethylene-perfluoroalkyl vinyl ether copolymer resins (PFA)), epoxy resins, glass-epoxy resins, and polyimide. In the case of using a ceramic material, it is preferable to use a glass ceramic material that is capable of being co-fired with a conductor material made of a low-resistance metal such as Au, Ag, or Cu that is capable of transmitting high-frequency signals. The thickness of the dielectric layer 2 made of these materials is set according to the frequency to be used or the application, for example.

If the dielectric layer 2 is made of a ceramic material, the signal conductor 3, the ground layer 4, the slot ground conductor 7, the slot signal conductor 8, the slot pattern conductor(s) 9a, the upper ground layer 11 or 17, and the lower ground layer 14 are formed of a metalized layer that is made primarily of a metal such as W, Mo, Mo—Mn, Au, Ag, or Cu. If the dielectric layer 2 is made of an organic resin, these conductors and layers are formed of a metal layer formed by a thick-film printing method, various types of thin-film forming methods, a plating method, a foil transfer method, or the like, or formed of a layer configured by forming a plating layer on such a metal layer, examples of which include a Cu layer, a Cr—Cu alloy layer, a layer configured by depositing a Ni plating layer and a Au plating layer on a Cr—Cu alloy layer, a layer configured by depositing a Ni—Cr alloy layer and a Au plating layer on a TaN layer, a layer configured by depositing a Pt layer and a Au plating layer on a Ti layer, and a layer configured by depositing a Pt layer and a Au plating layer on a Ni—Cr alloy layer. The thicknesses and widths thereof are set according to the frequency of high-frequency signals to be transmitted or the application, for example.

A known method may be used to form the signal conductor 3, the ground layer 4, the slot ground conductor 7, the slot signal conductor 8, the slot pattern conductor(s) 9a, the upper ground layer 11 or 17, and the lower ground layer 14. For example, if the dielectric layer 2 is made of glass ceramics, green sheets of glass ceramics to be formed into the dielectric layer 2 are prepared first and then conductor patterns for the signal conductor 3, the ground layer 4, the slot ground conductor 7, the slot signal conductor 8, the slot pattern conductor(s) 9a, the upper ground layer 11 or 17, and the lower ground layer 14 are formed by applying conductor pastes such as Ag in a predetermined shape on the green sheets by printing using a screen printing technique. In this case, the signal conductor 3, the slot ground conductor 7, the slot signal conductor 8, and the slot pattern conductor(s) 9a are formed on the same green sheet at the same time. Then, the green sheets with the conductor patterns having formed thereon are, for example, overlaid and bonded to one another by pressing so as to create a laminated body, which is then shaped by undergoing firing at 850 to 1000° C. Thereafter, films of plating such as Ni plating and Au plating are formed over the conductors exposed to the outer surface. If the dielectric layer 2 is made of an organic resin material, for example, the signal conductor 3, the ground layer 4, the slot ground conductor 7, the slot signal conductor 8, the slot pattern conductor(s) 9a, the upper ground layer 11 or 17, and the lower ground layer 14 are formed by transferring, to organic resin sheets, Cu foils that have been processed into the shapes of the conductor patterns for these conductors and layers, and laminating and bonding the organic resin sheets, on which the Cu foils have been transferred, with an adhesive.

If the dielectric layer 2 is made of ceramics such as glass ceramics, the through conductors 6, the ground-reinforcing conductors 6a, and the upper ground-reinforcing conductors 6b can be formed by, for example prior to the formation of the conductor patterns for the signal conductor 3, the ground layer 4, the slot ground conductor 7, the slot signal conductor 8, the slot pattern conductor(s) 9a, the upper ground layer 11 or 17, and the lower ground layer 14 in the aforementioned manufacturing method, forming through holes in green sheets in advance by metal molding or laser machining and filling the through holes with a similar conductor paste using a print process or the like. Similarly, if the dielectric layer 2 is made of an organic resin, organic resin sheets are used instead of green sheets, and through conductors may be formed in through holes by printing or plating of a conductor paste. The shield conductors 15 may also be formed in the same manner as the through conductors 6, the ground-reinforcing conductors 6a, and the upper ground-reinforcing conductors 6b.

### EXAMPLES

### Example 1

Simulations for verifying the effect of the line conversion structure of the invention were conducted using the example shown in FIGS. 4A to 4C as a simulation model. A loss in conversion from the microstrip line 1 to the slot line 5 was estimated by simulating a loss caused during processing in which a signal inputted from the microstrip line 1 was output to the output microstrip line 13 on the lower surface of the dielectric layer 2. The first opening 4a for coupling the slot line 5 and the output microstrip line 13 was provided in the ground layer 4 inside the dielectric layer 2. Assuming that the dielectric layer 2 was made of alumina, the relative dielectric constant was set to 8.6, the conductivity of the conductors was set to 6.6×10⁶ (S/m), and the signal frequency was set to 60 GHz. The thicknesses of the dielectric layer 2 and the lower dielectric layer 2a were set to 0.15 mm, and in order to set the impedance of the microstrip line 1 and the output microstrip line 13 to 50Ω, the widths of the signal conductor 3 and the output signal conductor 12 were set to 0.14 mm. In this case, the effective dielectric constant of the microstrip line 1 and the output microstrip line 13 was 6.3, and the wavelength of the signals at 60 GHz was 2.0 mm. The diameter of the through conductors 6 was set to 0.1 mm. The width of the slot 9 (the distance between the slot ground conductor 7 and the slot signal conductor 8) was set to 0.1 mm, and the length SL was set to 1.4 mm. The stub length ML of the output microstrip line 13 was set to 0.4 mm. The first opening 4a was assumed to have the shape of a rectangle of 1.8 mm×0.35 mm, and was disposed so that the slot 9 was located in the center of the first opening 4a when viewed from above.

The length L of the portion of the slot ground conductor 7 that was parallel to the signal conductor 3 with a gap in between (hereinafter referred to as a “parallel length L”) was set to 0.25 times (0.5 mm) the wavelength of signals transmitted through the microstrip line 1, and the distance D between the signal conductor 3 and the through conductor 6 was set to 0.13 times (0.26 mm) the signal wavelength.

The results of the simulations of the loss performed using the above-described simulation model were shown in FIG. 8. FIG. 8 is a graph showing the frequency characteristics of the loss caused between the microstrip line 1 and the output microstrip line 13 of the simulation model, the vertical axis indicating the loss and the horizontal axis the frequency. It can be seen from FIG. 8 that signals were transmitted in the range of approximately 50 to 70 GHz, and favorable electromagnetic coupling between the microstrip line 1 and the output microstrip line 13 was observed in the 60 GHz band, which indicates that the conversion from the microstrip line 1 into the slot line 5 was made favorably. The loss at 60 GHz was 1.1 dB.

Simulations were conducted using different parallel lengths L in the above simulation model, namely, 0.125 times (0.25 mm) the signal wavelength, 0.188 times (0.375 mm), 0.375 times (0.75 mm), 0.5 times (1.0 mm), 0.75 times (1.5 mm), and 1.0 times (2.0 mm). The results were collectively shown in FIG. 9. FIG. 9 is a graph showing a relationship between the loss and the parallel length L at 60 GHz. The parallel length L shown was normalized in accordance with the wavelength of 60 GHz signals transmitted through the microstrip line 1 (in the form of a ratio of the parallel length L to the wavelength). It can be seen from FIG. 9 that the loss was small, approximately 1.1 dB, if the parallel length L was less than or equal to 0.25 times the wavelength, but the loss increased sharply if the parallel length L exceeded 0.25 times the wavelength. The loss was in particular great for the parallel length L being 0.5 times the wavelength, which was due to the influence of resonance. Although there was no influence of resonance if the parallel length L was 0.75 times the wavelength, the loss in this case was approximately 2.1 dB, which was greater by the order of 1 dB than that for the parallel length L being less than or equal to 0.25 times the wavelength. This was because of accumulation of losses caused in two line conversion structures, namely, the line conversion structure from the microstrip line to the coplanar line and the line conversion structure from the coplanar line to the slot line, that were passed through when converting the microstrip line 1 into the slot line 5. If the parallel length L was 1.0 times the wavelength, the loss increased again due to the influence of resonance. In addition, in the case where the parallel length was greater than or equal to 1.0 times the wavelength and if the parallel length was 0.5n times the wavelength (n being a positive integer), the loss would increase similarly due to the influence of resonance.

### Example 2

Simulations were conducted using different distances D between the signal conductor 3 and the through conductor 6 that was located closest to the portion parallel to the signal conductor 3 of the above simulation model (hereinafter simply referred to as the “distance D”), namely, 0.075 times (0.15 mm) the signal wavelength, 0.1 times (0.2 mm), 0.188 times (0.375 mm), 0.25 times (0.5 mm), and 0.375 times (0.75 mm). The results were collectively shown in FIG. 10. FIG. 10 is a graph showing a relationship between the loss and the distance D between the signal conductor 3 and the through conductor 6 at 60 GHz. The distance D between the signal conductor 3 and the through conductor 6 shown was normalized in accordance with the wavelength of 60 GHz signals transmitted through the microstrip line 1 (in the form of a ratio of the distance D to the wavelength). It can be seen from FIG. 10 that the loss was small, approximately 1.1 dB, if the distance D was less than or equal to 0.13 times the wavelength, but the loss increased sharply if the distance D exceeds 0.13 times the wavelength. The loss was in particular great for the distance D being 0.25 times the wavelength, which was due to the influence of resonance as described above. Similarly, if the distance D was 0.25n times (n being a positive integer), the loss would increase due to the influence of resonance. Although there was no influence of resonance for the distance D being 0.38 times the wavelength, the loss in this case was approximately 2.1 dB, which was greater by the order of 1 dB than that for the distance D being less than or equal to 0.13 times the wavelength. This was considered because of a loss caused by an increase in the length of a transmission path when the potential of the ground layer 4 immediately below the signal conductor 3 of the microstrip line 1 was transmitted to the slot ground conductor 7 via the through conductors 6.

### Example 3

Simulations for verifying the effect of the antenna of the invention were conducted using the example shown in FIGS. 6A to 6C as a simulation model. The bandwidth of the antenna was estimated from the reflection characteristics of signals that were inputted from the microstrip line 1. The first opening 4a for coupling the slot line 5 and the dielectric matching unit was provided in the ground layer 4 on the lower surface of the dielectric layer 2. Assuming that the dielectric layer 2 and the lower dielectric layer 2a were made of alumina, the relative dielectric constant was set to 8.6, the conductivity of the conductors was set to 6.6×10⁶ (S/m), and the signal frequency was set to 60 GHz. The thickness of the dielectric layer 2 was set to 0.15 mm and the thickness of the lower dielectric layer 2a to 0.4 mm, and in order to set the impedance of the microstrip line 1 to 50Ω, the width of the signal conductor 3 was set to 0.14 mm. The diameters of the through conductors 6 and the shield conductors 15 were set to 0.1 mm. The width of the slot 9 (the distance between the slot ground conductor 7 and the slot signal conductor 8) was set to 0.1 mm, and the length SL was set to 1.4 mm. The first opening 4a was assumed to have the shape of a rectangle of 1.8 mm×0.35 mm, and was disposed so that the slot 9 was located in the center of the first opening 4a when viewed from above. The shield conductors 15 were arranged at 0.3 mm pitch so that their center positions were located on the sides of a rectangle of 3.6 mm×1.5 mm. The second opening 14a was assumed to have the shape of a rectangle of 3.6 mm×1.5 mm. The rectangle that connected the shield conductors 15 and the second opening 14a were disposed so as to make their centers coincide with the center of the first opening 4a.

The results of the simulations of the reflection performed using the above simulation model were shown in FIG. 11. FIG. 11 is a graph showing a frequency characteristic of the reflection of high-frequency signals to be inputted from the microstrip line 1 of the simulation model, the vertical axis indicating the reflection and the horizontal axis the frequency. It can be seen from FIG. 11 that the reflection was small, −10 dB or less, in the range of approximately 57 to 75 GHz, which indicated that the antenna emitted high-frequency signals into the space over a wide band.

[Test for Verifying Effect of Suppressing Reduction in Gain of Antenna]

Simulations for verifying the effect of suppressing a reduction in the gain of the antenna were conducted using the example shown in FIGS. 7A to 7C as a simulation model.

<Relationship between Gain of Antenna and Slot Pattern Width>

(Test Case 1)

The first opening 4a for coupling the slot line 5 and the dielectric matching unit was provided in the ground layer 4 on the lower surface of the dielectric layer 2. Assuming that the upper dielectric layer 16, the dielectric layer 2, and the lower dielectric layer 2a were made of alumina, the relative dielectric constant was set to 9.2, the conductivity of the conductors assumed to be metalized with tungsten was set to 6.6×10⁶ (S/m), and the signal frequency was set to 60 GHz. The thicknesses of the upper dielectric layer 16 and the dielectric layer 2 were set to 0.125 mm, the thickness of the lower dielectric layer 2a was set to 0.4 mm, and the width of the signal conductor 3 of the strip line 18 was set to 0.1 mm. The gap between the slot ground conductor 7 and the signal conductor 3 was set to 0.1 mm. The diameters of the through conductors 6 and the shield conductors 15 were set to 0.1 mm, and the distance D between the through conductor 6 and the signal conductor 3 was set to 0.23 mm. The width of the slot 9 (the distance between the slot ground conductor 7 and the slot signal conductor 8) was set to 0.1 mm, and the length SL was set to 0.8 mm. The width of the slot signal conductor 8 was set to 0.205 mm. Then, the two slot pattern conductors 9a were configured on the upper surface of the dielectric layer 2 so as to close both end portions of the slot 9, and the length of the portions of the slot pattern conductors 9a that were perpendicular to the signal conductor 3 (slot pattern width SW) was set to 0.35 times (0.577 mm) the wavelength of signals transmitted through the strip line 18. Note that, in Test Case 1, the simulations were conducted on the assumption that neither ground-reinforcing conductors 6a nor the upper ground-reinforcing conductors 6b were formed.

(Test Case 2)

In Test Case 2, simulations were conducted in the same manner as in Test Case 1, with the exception that the length of the portions of the slot pattern conductors 9a that were perpendicular to the signal conductor 3 (slot pattern width SW) was set to 0.3 times (0.495 mm) the wavelength of signals transmitted through the strip line 18.

(Test Case 3)

In Test Case 3, simulations were conducted in the same manner as in Test Case 1, with the exception that the length of the portions of the slot pattern conductors 9a that were perpendicular to the signal conductor 3 (slot pattern width SW) was set to 0.25 times (0.412 mm) the wavelength of signals transmitted through the strip line 18.

(Test Case 4)

In Test Case 4, simulations were conducted in the same manner as in Test Case 1, with the exception that the length of the portions of the slot pattern conductors 9a that were perpendicular to the signal conductor 3 (slot pattern width SW) was set to 0.2 times (0.33 mm) the wavelength of signals transmitted through the strip line 18.

(Test Case 5)

In Test Case 5, simulations were conducted in the same manner as in Test Case 1, with the exception that the length of the portions of the slot pattern conductors 9a that were perpendicular to the signal conductor 3 (slot pattern width SW) was set to 0.15 times (0.247 mm) the wavelength of signals transmitted through the strip line 18.

The results of the simulations of the gain performed using the simulation model in Test Cases 1 to 5 described above were shown in Table 1 and FIGS. 12 and 13A to 13C. FIG. 12 is a graph showing the relationship between the gain of the antenna and the slot pattern width in the case where no ground-reinforcing conductors are formed. In FIG. 12, the vertical axis indicates the gain (dBi), and the horizontal axis indicates the slot pattern width with respect to the wavelength. FIGS. 13A to 13C are graphs showing the simulation results for the gain of the antenna in Test Cases 1, 3, and 5. In FIGS. 13A to 13C, FIG. 13A shows the simulation results for Test Case 1, FIG. 13B for Test Case 3, and FIG. 13C for Test Case 5, the vertical axis indicating the gain (dBi) and the horizontal axis indicating the angle (deg). In FIGS. 13A to 13C, the solid line A indicates the gain of the antenna in a plane that is parallel to the signal conductor 3 and perpendicular to the dielectric layer 2, and the broken line B indicates the gain of the antenna in a plane that is perpendicular to the signal conductor 3 and perpendicular to the dielectric layer 2.

TABLE 1

| | Slot Patten Width with | | |
|---|---|---|---|
| | respect to Wavelength | Actual Dimension | Gain |
| | (times) | (mm) | (dBi) |
| Test Case 1 | 0.35 | 0.577 | 5.3 |
| Test Case 2 | 0.3 | 0.495 | 5.2 |
| Test Case 3 | 0.25 | 0.412 | 3.5 |
| Test Case 4 | 0.2 | 0.33 | 2.9 |
| Test Case 5 | 0.15 | 0.247 | 1.8 |

As can be seen from Table 1 and FIGS. 12 and 13A to 13C, there was no noticeable reduction in gain if the slot pattern width of the slot pattern conductors 9a was greater than or equal to 0.3 times the signal wavelength, but there was a considerable reduction in gain if the slot pattern width was less than or equal to 0.25 times the signal wavelength.

<Relationship between Gain of Antenna and Clearance between Ground-Reinforcing Conductors and End Portions of Slot>

(Test Case 6)

In Test Case 6, simulations were conducted in the same manner as in Test Case 1, with the exception that the length of the portions of the slot pattern conductors 9a that were perpendicular to the signal conductor 3 (slot pattern width SW) was set to 0.25 times (0.412 mm) the wavelength of signals transmitted through the strip line 18, and the ground-reinforcing conductors 6a were disposed corresponding to the respective end portions of the slot 9 at positions that were spaced 0.25 times the wavelength of signals transmitted through the strip line 18 from the respective end portions of the slot 9 in directions away from the signal conductor 3 (that is, the clearance between the conductors and the end portions of the slot 9 was 0.25 times the wavelength). Note that in Test Case 6, the simulations were conducted on the assumption that no upper ground-reinforcing conductors 6b were formed.

(Test Case 7)

In Test Case 7, simulations were conducted in the same manner as in Test Case 6, with the exception that the clearance between the ground-reinforcing conductors 6a and the end portions of the slot 9 was set to 0.125 times the wavelength.

(Test Case 8)

In Test Case 8, simulations were conducted in the same manner as in Test Case 6, with the exception that the clearance between the ground-reinforcing conductors 6a and the end portions of the slot 9 was set to 0 times the wavelength, that is, the center positions of the ground-reinforcing conductors 6a were made coincide with the positions of the end portions of the slot 9.

(Test Case 9)

In Test Case 9, simulations were conducted in the same manner as in Test Case 6, with the exception that the length of the portions of the slot pattern conductors 9a that were perpendicular to the signal conductor 3 (slot pattern width SW) was set to 0.15 times (0.247 mm) the wavelength of signals transmitted through the strip line 18, and the clearance between the ground-reinforcing conductors 6a and the end portions of the slot 9 was set to 0.15 times the wavelength.

(Test Case 10)

In Test Case 10, simulations were conducted in the same manner as in Test Case 6, with the exception that the length of the portions of the slot pattern conductors 9a that were perpendicular to the signal conductor 3 (slot pattern width SW) was set to 0.15 times (0.247 mm) the wavelength of signals transmitted through the strip line 18, and the clearance between the ground-reinforcing conductors 6a and the end portions of the slot 9 was set to 0 times the wavelength, that is, the center positions of the ground-reinforcing conductors 6a were made coincide with the positions of the end portions of the slot 9.

The results of the simulations of the gain performed using the simulation model in Test Cases 6 to 10 described above were shown in Table 2 and FIGS. 14 and 15A to 15C. FIG. 14 is a graph showing the relationship between the gain of the antenna and the clearance between the ground-reinforcing conductors and the end portions of the slot. In FIG. 14, the vertical axis indicates the gain (dBi), and the horizontal axis indicates the clearance between the ground-reinforcing conductors and the end portions of the slot with respect to the wavelength. Note that in FIG. 14, A denotes the wavelength of signals transmitted through the strip line 18. FIGS. 15A to 15C are graphs showing the simulation results for the gain of the antenna in Test Cases 6, 7, and 8. In FIGS. 15A to 15C, FIG. 15A shows the simulation results for Test Case 6, FIG. 15B for Test Case 7, and FIG. 15C for Test Case 8, the vertical axis indicating the gain (dBi) and the horizontal axis the angle (deg). In FIGS. 15A to 15C, the solid line A indicates the gain of the antenna in a plane that is parallel to the signal conductor 3 and perpendicular to the dielectric layer 2, and the broken line B indicates the gain of the antenna in a plane that is perpendicular to the signal conductor 3 and perpendicular to the dielectric layer 2.

TABLE 2

| | | Clearance between Ground- | |
|---|---|---|---|
| | | Reinforcing Conductors and | |
| | Slot Patten Width with | End portions of Slot with | |
| | respect to Wavelength | respect to Wavelength | Gain |
| | (times) | (times) | (dBi) |
| Test Case 6 | 0.25 | 0.25 | 4.6 |
| Test Case 7 | 0.25 | 0.125 | 4.7 |
| Test Case 8 | 0.25 | 0 | 5 |
| Test Case 9 | 0.15 | 0.15 | 4.2 |
| Test Case 10 | 0.15 | 0 | 4.5 |

As can be seen from Table 2 and FIGS. 14 and 15A to 15C, by forming the ground-reinforcing conductors 6a in a region within 0.25 times the signal wavelength from the end portions of the slot 9, a reduction in gain was suppressed better than in Test Cases 3 and 5 described above in which no ground-reinforcing conductors 6a were formed.

<Position where Ground-Reinforcing Conductor is Disposed>

(Test Case 11)

In Test Case 11, simulations were conducted in the same manner as in Test Case 1, with the exception that the length of the portions of the slot pattern conductors 9a that were perpendicular to the signal conductor 3 (slot pattern width SW) was set to 0.25 times (0.412 mm) the wavelength of signals transmitted through the strip line 18, and the ground-reinforcing conductors 6a were provided on the extension of the signal conductor 3 so that the ground-reinforcing conductors 6a connected the slot signal conductor 8 and the ground layer 4.

The results of the simulations of the gain performed using the simulation model in Test Case 11 described above were shown in FIG. 16. FIG. 16 is a graph showing the simulation results for the gain of the antenna in Test Case 11. In FIG. 16, the vertical axis indicates the gain (dBi), and the horizontal axis the angle (deg). In FIG. 16, the solid line A indicates the gain of the antenna in a plane that is parallel to the signal conductor 3 and perpendicular to the dielectric layer 2, and the broken line B indicates the gain of the antenna in a plane that is perpendicular to the signal conductor 3 and perpendicular to the dielectric layer 2. It can be seen from FIG. 16 that the effect of suppressing a reduction in gain was not obtained if the ground-reinforcing conductors 6a were provided so as to connect the slot signal conductor 8 and the ground layer 4.

<Number of Ground-Reinforcing Conductors Disposed>

(Test Case 12)

In Test Case 12, simulations were conducted in the same manner as in Test Case 1, with the exception that the length of the portions of the slot pattern conductors 9a that were perpendicular to the signal conductor 3 (slot pattern width SW) was set to 0.15 times (0.247 mm) the wavelength of signals transmitted through the strip line 18, and a ground-reinforcing conductor 6a was disposed corresponding to only one end portion of the slot 9 at a position that was spaced 0.15 times the wavelength of signals transmitted through the strip line 18 from the one end portion of the slot 9 in a direction away from the signal conductor 3 (that is, the clearance between the conductor and the one end of the slot 9 was 0.15 times the wavelength).

The results of the simulations of the gain performed using the simulation model in Test Case 12 described above were shown in Table 3.

TABLE 3

| | | Clearance between Ground- | |
|---|---|---|---|
| | | Reinforcing Conductor and | |
| | Slot Patten Width with | End portion of Slot with | |
| | respect to Wavelength | respect to Wavelength | Gain |
| | (times) | (times) | (dBi) |
| Test Case 12 | 0.15 | 0.15 (only one end) | 2.8 |
| Test Case 5 | 0.15 | — | 1.8 |

As can be seen from Table 3, even if the ground-reinforcing conductor 6a was disposed corresponding to only one end portion of the slot 9, a reduction in gain was suppressed better than in Test Case 5 in which no ground-reinforcing conductors 6a were formed.

<Symmetry of Positions where Two Ground-Reinforcing Conductors are Disposed>

(Test Case 13)

In Test Case 13, simulations were conducted in the same manner as in Test Case 1, with the exception that the length of the portions of the slot pattern conductors 9a that were perpendicular to the signal conductor 3 (slot pattern width SW) was set to 0.15 times (0.247 mm) the wavelength of signals transmitted through the strip line 18, and the two ground-reinforcing conductors 6a were disposed at positions, specifically, at the position spaced 0.15 times the signal wavelength from one end portion of the slot 9 (i.e., the clearance between the conductor and the end of the slot 9 was 0.15 times the wavelength) and at the position spaced 0 times the signal wavelength from the other end portion of the slot 9 (i.e., the center position of the ground-reinforcing conductor 6a was made coincide with the position of the end portion of the slot 9). In other words, in Test Case 13, the positions where the two ground-reinforcing conductors 6a were disposed were asymmetrical with respect to the signal conductor 3.

The results of the simulation of the gain performed using the simulation model in Test Case 13 described above were shown in Table 4.

TABLE 4

| | | Clearance | | |
|---|---|---|---|---|
| | | between | | |
| | | Ground- | Clearance between | |
| | Slot Patten | Reinforcing | Ground-Reinforcing | |
| | Width with | Conductor | Conductor | |
| | respect to | and One End | and Other | |
| | Wavelength | portion of Slot | End Portion of Slot | Gain |
| | (times) | (times) | (times) | (dBi) |
| Test Case 13 | 0.15 | 0.15 | 0 | 2.8 |
| Test Case 5 | 0.15 | — | — | 1.8 |
| Test case 9 | 0.15 | 0.15 | 0.15 | 4.2 |

As can be seen from Table 4, if the two ground-reinforcing conductors 6a were disposed asymmetrically, although the effect of suppressing a reduction in gain was lower than in Test Case 9 in which they are disposed symmetrically, a reduction in gain was suppressed better than in Test Case 5 in which no ground-reinforcing conductors 6a were formed.

<Effect of Upper Ground-Reinforcing Conductor to Suppress Reduction in Gain>

(Test Case 14)

In Test Case 14, simulations were conducted in the same manner as in Test Case 1, with the exception that the length of the portions of the slot pattern conductors 9a that were perpendicular to the signal conductor 3 (slot pattern width SW) was set to 0.15 times (0.247 mm) the wavelength of signals transmitted through the strip line 18, the ground-reinforcing conductors 6a were disposed corresponding to the respective end portions of the slot 9 at positions spaced 0.15 times the signal wavelength from the end portions of the slot 9 in directions away from the signal conductor 3 (i.e., the clearance between the conductors and the end portions of the slot 9 was 0.15 times the wavelength), and the upper ground-reinforcing conductors 6b were disposed corresponding to the respective end portions of the slot 9 at positions spaced 0.15 times the signal wavelength from the end portions of the slot 9 in directions away from the signal conductor 3 (i.e., the clearance between the conductors and the end portions of the slot 9 was 0.15 times the wavelength).

(Test Case 15)

In Test Case 15, simulations were conducted in the same manner as in Test Case 14, with the exception that the upper ground-reinforcing conductors 6b were disposed corresponding to the respective end portions of the slot 9 at positions spaced 0 times the signal wavelength from the end portions of the slot 9 in directions away from the signal conductor 3 (i.e., the center positions of the upper ground-reinforcing conductors 6b were made coincide with the positions of the ends of the slot 9). In other words, in Test Case 15, the upper ground-reinforcing conductors 6b were disposed at positions that were shifted from the ground-reinforcing conductors 6a.

The results of the simulation of the gain performed using the simulation model in Test Cases 14 and 15 described above were shown in Table 5.

TABLE 5

| | | | Clearance | |
|---|---|---|---|---|
| | | | between Upper | |
| | | | Ground- | |
| | | Clearance between | Reinforcing | |
| | | Ground-Reinforcing | Conductors | |
| | Slot Patten | Conductors and End | and End | |
| | Width with | Portions of Slot with | Portions of Slot | |
| | respect to | respect to | with respect to | |
| | Wavelength | Wavelength | Wavelength | Gain |
| | (times) | (times) | (times) | (dBi) |
| Test Case 14 | 0.15 | 0.15 | 0.15 | 4.9 |
| Test Case 15 | 0.15 | 0.15 | 0 | 4.4 |
| Test Case 5 | 0.15 | — | — | 1.8 |
| Test case 9 | 0.15 | 0.15 | — | 4.2 |

As can be seen from Table 6, the provision of the upper ground-reinforcing conductors 6b further suppressed a reduction in gain as compared with Test Case 9 in which no upper ground-reinforcing conductors 6b were provided. Also, a comparison between Test Case 14 and Test Case 15 showed that a reduction in gain was further suppressed by not disposing the upper ground-reinforcing conductors 6b at positions shifted from the ground-reinforcing conductors 6a.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### REFERENCE SIGNS LIST

1: Microstrip line
2: Dielectric layer
2a: Lower dielectric layer
3: Signal conductor
4: Ground layer
4a: First opening
5: Slot line
6: Through conductor
6a: Ground-reinforcing conductor
6b: Upper ground-reinforcing conductor
7: Slot ground conductor
8: Slot signal conductor
9: Slot
9a: Slot pattern conductor
10, 16: Upper dielectric layer
11, 17: Upper ground layer
12: Output signal conductor
13: Output microstrip line
14: Lower ground layer
14a: Second opening
15: Shield conductor
18: Strip line

1. A line conversion structure for converting a high-frequency transmission line into a slot line, comprising:
a high-frequency transmission line comprising a dielectric layer, a signal conductor disposed on an upper surface of the dielectric layer, and a ground layer disposed on a lower surface of the dielectric layer; and
a slot line comprising a slot ground conductor disposed on the upper surface of the dielectric layer and connected to the ground layer with a through conductor that passes through the dielectric layer, a slot signal conductor disposed on the upper surface of the dielectric layer, and a slot disposed between the slot ground conductor and the slot signal conductor,
wherein the signal conductor of the high-frequency transmission line is orthogonal to the slot ground conductor and the slot, with a gap between the signal conductor and the slot ground conductor, and an end of the signal conductor is connected to the slot signal conductor, and
a length of a portion of the slot ground conductor, the portion being parallel to the signal conductor with the gap, is less than or equal to 0.25 times a wavelength of a signal transmitted through the high-frequency transmission line.

2. The line conversion structure according to claim 1, wherein a distance between the through conductor, that is located closest to the portion of the slot ground conductor parallel to the signal conductor with the gap, and the signal conductor is less than or equal to 0.13 times the wavelength of the signal transmitted through the high-frequency transmission line.

3. The line conversion structure according to claim 1, wherein an upper ground layer is formed via an upper dielectric layer so as to cover a portion of the signal conductor which portion is orthogonal to the slot line, the gap, and a portion of the slot line between the gap and the slot signal conductor.

4. The line conversion structure according to claim 1, wherein a slot pattern conductor on the upper surface of the dielectric layer is configured to close at least one end portion of the slot.

5. The line conversion structure according to claim 4, wherein
the slot pattern conductor is disposed at two positions on the upper surface of the dielectric layer so as to close both end portions of the slot,
a length of a portion of each of the slot pattern conductors, the portion being perpendicular to the signal conductor, is less than or equal to 0.25 times the wavelength of the signal transmitted through the high-frequency transmission line, and
a ground-reinforcing conductor, that passes through the dielectric layer and connects the slot ground conductor and the ground layer, is formed in a region that extends from each end portion of the slot in a direction away from the signal conductor and ranges within 0.25 times the wavelength of the signal transmitted through the high-frequency transmission line.

6. The line conversion structure according to claim 5, wherein the high-frequency transmission line comprises the dielectric layer, the signal conductor, the ground layer, an upper dielectric layer formed on the upper surface of the dielectric layer, and an upper ground layer formed on an upper surface of the upper dielectric layer.

7. The line conversion structure according to claim 6, wherein the ground-reinforcing conductor is configured to pass through the upper dielectric layer and to connect the slot ground conductor and the upper ground layer.

8. An antenna, comprising:
the line conversion structure according to claim 1, in which both end portions of the slot are closed;
a lower dielectric layer formed on the lower surface of the dielectric layer;
a lower ground layer formed on a lower surface of the lower dielectric layer;
a first opening formed in a portion of the ground layer that faces the slot;
a second opening formed in a portion of the lower ground layer that faces the slot; and
a plurality of shield conductors configured to surround the first opening and the second opening in a plan view, and to connect the ground layer and the lower ground layer.

9. The antenna according to claim 8, wherein the first opening has a shorter length than the second opening in a direction parallel to the signal conductor.

10. The line conversion structure according to claim 2, wherein an upper ground layer is formed via an upper dielectric layer so as to cover a portion of the signal conductor which portion is orthogonal to the slot line, the gap, and a portion of the slot line between the gap and the slot signal conductor.

11. The line conversion structure according to claim 2, wherein a slot pattern conductor on the upper surface of the dielectric layer is configured to close at least one end of the slot.

12. The line conversion structure according to claim 3, wherein a slot pattern conductor on the upper surface of the dielectric layer is configured to close at least one end of the slot.
